(19) United States
(12) Patent Application Publication
(10) Pub. No.: US 2015/0244778 A1
(43) Pub. Date: Aug. 27, 2015

(54) Assembling of Isolated Remote Data

(71) Applicant: Yin Sheng ZHANG, Richmond (CA)

(72) Inventor: Yin Sheng Zhang, Richmond (CA)

(21) Appl. No.: 14/432,197

(22) PCT Filed: Jun. 11, 2013
(86) PCT No.: PCT/IB2013/054785

§ 371 Date: Mar. 28, 2015

(51) Int. Cl. H04L 29/08; G06F 15/167; H04L 29/06

(52) U.S. Cl. CPC H04L 67/10; H04L 67/06; H04L 67/42; G06F 15/167

(57) ABSTRACT

A method, system and product for securely storing data file at a remote location by splitting and reassembling said files is provided. AIR Storage is a technique comprising splitting into two separate halves a complete file that is stored on a client platform in order to form two separate data split files (DSF); storing a first DSF at a remote location, referred to as a remote DSF, wherein the remote location comprises a network server; storing a second DSF on a local device, referred to as a local DSF, wherein the local device comprises an external memory operably connected to said client platform, wherein said remote DSF and local DSF lose the ability to display informative content; reassembling the two halves to rebuild said complete file, wherein the splitting and assembling are performed in Random Access Memory on said client platform; and displaying said reassembled file on said client platform. AIR ware is a processing unit located on the client platform, whose main function is to split the complete file into the remote DSF and local DSF, to make the DSFs lose their ability to display informative content, and to separately send the different DSFs on the local device operably connected to said client platform and on the network server. When the complete file needs to be used, AIR ware then collects the two different DSFs from both locations according to user instructions, and reassembles the two different DSFs into said complete file on the client platform.

### TECHNICAL FIELD

Assembling of isolated remote data is the technology of data storage method, process and also data security measure, this technology belongs to the field of IT, AIR Storage is its abbreviation.

AIR Storage is characterized by the use of a dedicated hardware device, or a specific application program, and by the method and process of data splitting to transform a stored data into two separate data in a form of “bad data” on client platform, so that the split data can not display any meaningful informative content after the transformation, then store one of the two split data to an isolated remote location (remote DSF) while keeping the other split data on the client platform (local DSF). When the complete data needs to be used, the dedicated hardware device or specific computer application program will collect related split data from both the client platform and the isolated remote location, and restore the two collected “bad data” into its original form on the client platform, so that the data content with meaningful information is recovered. In AIR Storage, the two split data are separately stored on two different platforms, which are client platform and network server, and the dedicated hardware device or specific computer application program to be adopted is AIR ware.

In AIR storage, a user file is split into two parts via an AIR ware computer application program or hardware of AIR ware that integrated specific application programs, and two parts of the split file are stored separately on platforms of both end of network. When user needs to use the complete file, the two parts of split file will be assembled via AIR ware on client computer, and then the file recovers to its original complete status.

A complete file is consciously to be split into two incomplete files in data structures, and to be turned into non-informative one, because the data splitting files are separated stored on platforms away from each other, so each one of data splitting files completely loses the opportunity to display any informative content individually, so achieving the purpose of protecting data from unauthorized viewing.

However, the two data splitting files always keep a close intrinsic relationship through predefined procedure and system mechanism, user can use the data splitting file that stored on client platform to control the data splitting file that stored on the remote location, and request data assembling and file recovery at any time while network connection is available. All the data splitting and assembling processes are done automatically through special application program and specific hardware device within system, and these processes are done without user interference.

AIR storage uses the method of data splitting to obtain the security of user data, and use the method of data assembling to obtain the recovery of informative content of user data, while the more important point is that the privileges of control of entire data splitting and assembling processes, as well as the privilege of data confidentiality is only in the operation by data owner, third party unable to intervene.

### BACKGROUND OF THE INVENTION

In recent years, various industries and personnel on all levels of society have adopted computer technology to handle their business, service and transaction, the computer they use producing large amounts of user data every day. Government has confidential document, enterprise has trade secret, bank has confidential financial information of customer, ordinary computer user has privacy, and all of these computer users are eager to find a safe and stringent way to save their data.

Storing data on a local external memory device or similar medium, or storing data on the network server, these two methods are commonly used today, however they both have their own advantages, and also exist in some fatal weakness, for example, when the file is stored on a network server, there is hidden risk of losing control of data information, when the file is stored in a local external memory device or similar medium, there is the threat of malicious stealing data information.

However, when comes to the solution of above problems, users have to face the reality that most of the claimed secure data storage methods require user to remember endless new password, require user to increase cumbersome operation links like cloud storage's repeated account login process, or require user to use new hardware with data security features. But practice has proved that today's many new methods such as increasing data security program and processes, and changing the hardware configuration of storage devices are only slightly enhancing the security of data, and can not make user to be fully at ease.

In response to this situation, AIR Storage is precisely the technical solution for solving weakness of two commonly used methods mentioned above, and also fully absorbs the advantages of the two methods.

AIR Storage splits the user data in order to destroy the continuity of data, it disrupts the data structure of a complete file to undermine the informative significance of file, at same time, AIR Storage stores the split data files to different platforms, local data splitting file is stored in client computer, and remote data splitting file is stored on a remote location comprising a server through the network. Because each one of the splitting data alone does not contain enough structure information to be recovered into its compete form by any third party on its storage platform, so this achieves the effect of absolute secrecy, which also ensures the control privilege of file owner for the operation of data assembling and file recovery.

Through using the method provided by AIR Storage, no one but the owner himself can get complete data information, this enhances the security of the stored data greatly.

AIR Storage also enhances the flexibility of data storage. In this invention, the difference between types of storage medium is narrowed. Data is stored in the form of data splitting file, and thus, whether the data is stored on a remote server, or stored on a local external memory device or similar medium, they are equally safe.

Furthermore, the AIR storage enhances the controllability of the stored data. The data splitting file stored on the remote server is controlled by the data splitting file stored on the local external memory, but the control of local platform rests on the file owner's operation, only file owner is entitled to assembling files.

AIR Storage can be used in different computer system, which are traditional computer systems that we are commonly using today, and FOS Computer system.

FOS Computer is another invention of the same inventor of AIR Storage, however AIR Storage can be used in both traditional computer system and FOS Computer.

In AIR Storage, a computer-generated file was split into two data splitting files before transmitting to storage medium, one of the data splitting files is transmitted to a local external memory device or similar medium for storage, and another is transmitted to a remote server for storage.

Two data splitting files lose ability of displaying meaningful informative content, thus the owner of original user generated file must perform a data assembling process to recover the two data splitting files to its original one file format before the original user generated file can be used again.

In AIR Storage, file data splitting, file directional transmission, file flow to local Random Access Memory, and file assembling, all these operations are performed through the process of AIR ware.

In traditional computer systems, AIR ware is installed on a local platform, which can be a dedicated device hardware for AIR storage, AIR ware can also be a specialized computer application software installed on a wide variety of external storage devices. In short, AIR Storage only functions when AIR Ware is in the system.

In FOS Computer system, AIR Storage is native to computer operating system, and it becomes a part of FOS Computer functions.

AIR storage can significantly improve the security of stored data, having real user needs. Today many mature advanced technologies have paved the way for next generation of data storage method like AIR storage, therefore AIR storage already has full feasibility.

### 1. Data Striping Techniques and AIR Storage

Strip technology is a technology that automatically balances I/O load across multiple physical disk, which split continuous data into same size data block, and write the data blocks into each of different disk array. The purpose of striping technology is mainly for avoiding disk conflict. Most disk systems will limit the number of visits (I/O operations per second, IOPS) and data transfer rate (amount of data transmitted per second, TPS), when these limits are reached, the disk must wait the behind process that needs to access, which is the disk conflict.

In addition, striping technology is also widely used in the stored data backup on client platform and the data dispersed storage on server platform.

RAID disk is a typical product of the strip technology, which combines several separated disks (physical disk) in different ways to a disk group (logical disk), thus providing greater memory performance than a single disk's. Although its main technical features and technical aim is to avoid disk conflict, or to backup data: when user data is damaged, the backup information can be used to make the damaged data to be restored in order to protect the security of user data, this differs from the design concept of AIR Storage, but it uses the method of data splitting and sub-disk storage provides AIR Storage an important reference and proof of feasibility.

### 2. Cloud Storage and AIR Storage

Cloud storage is a new concept extended and developed from the concept of cloud computing, which by use of functions of cluster application, network technology or distributed network file system etc. on the basis of the application software to make different types of memory devices (including many of switches, routers, firewalls and servers) work together, and provide data storage service and access service outwardly together.

AIR storage is also a data storage technology, if it is used in traditional computer models, part of the splitting data will through network to be stored to a remote location comprising a server on the basis of a special application software, which maybe directly by means of cloud storage technology, and now the huge global development and application foundation of cloud storage technology can also be the reference for AIR Storage.

AIR Storage and cloud storage are using the network for data storage, but the difference is that cloud storage completely relies on a network server, but AIR Storage takes advantage of both of network platform and client platform, and the initiative lies on the client platform.

### 3. Network Data Transmission Technology and AIR Storage

Data transmission technology is a method and apparatus that one or more data channels or links follow a common communication protocol to transmit data between data sources and data sinks.

At present, the network broadband penetration of some developed countries is more than 60% or 70%, even in some developing countries as China, the network coverage is expected to exceed 60%, in addition, according to the report of Business Insider (February in 2014), IBM recently announced a digital and analog signal switching chip in the International Solid-State Circuits Conference that the chip makes the speed of internet raised to the level of 200 to 400 Gbps (i.e. 200-400 times gigabit broadband) under the premise of low-power consumption.

These technological advances are very conducive to the smooth development of AIR Storage.

In short, IT industry tireless efforts on data security issues, and made a lot of achievements, which provided the conditions for development of AIR Storage, such as:

Rapid development of chip technology allows some larger capacity applications to be integrated on a smaller size chip, which facilitate AIR ware development;

Appearing of the concept of mobile data changes the state that static data always stored in an unchangeable medium, many manufacturers have begun to reform their products based on this concept accordingly, more and more new data storage device are equipped with the automated tiered storage function, and the achievement of automated tiered storage technology will also help AIR Storage from vision into reality, and further refine the idea of AIR Storage;

Mobile IT devices are widely welcomed by users, and become more and more sophisticated one equipped with more and more functions, which in future may become the deployment apparatus of AIR ware function.

The innovation process of data storage method is also the process that fighting with a variety of threats, IT industry design data security method based on data type and user concern, has accumulated a lot of experience, what method has flaw, what method easy to be reverse restricted, and what method is effective, which are no longer the very difficult thing to judge.

AIR Storage is a new effort to eliminate the flaws in some existing methods, against the reverse restriction of third party, and enhance the effectiveness of some existing methods.

By comparison with other data striping techniques, AIR Storage can clearly demonstrate the following uniqueness:

One file is split to form two data splitting files for isolated storage, and each of the two data splitting files is stored in a local external memory device or similar medium and a device at remote location comprising a server independently for each other.

The data splitting file that stored on a network server is not access able by user without using method provided in AIR Storage, and only local DSF can be accessed directly by user. By clicking on data splitting file stored on local device, a request will be sent to the network server for downloading the data splitting file that is stored on the network server.

When AIR ware is an hardware device with specific application program, and use the AIR ware to split and assemble file data, the data splitting files contain both kernel code of AIR ware hardware and internal code of DSF.

Data are stored in both ends of the network, but the operations of data splitting and assembling are performed in the Random Access Memory on the client platform.

### BRIEF DESCRIPTION OF DRAWING

FIG. 1: AIR Storage DSF Saving Process

In FIG. 1, User Generated File is split by AIR ware into Local Data Splitting File and Remote Data Splitting File. Local Data Splitting File is stored on client computer. Remote Data Splitting File is sent to and stored on server.

FIG. 2: AIR Storage DSF Assembling Process

In FIG. 2, Local Data Splitting File is processed by AIR ware to Random Access Memory on client computer. Remote Data Splitting File is downloaded and processed by AIR ware to Random Access Memory on Client Computer. AIR ware then puts Local Data Splitting File and Remote Data Splitting File together and restores them to original user generated file.

FIG. 3: Similar Technology Contrast

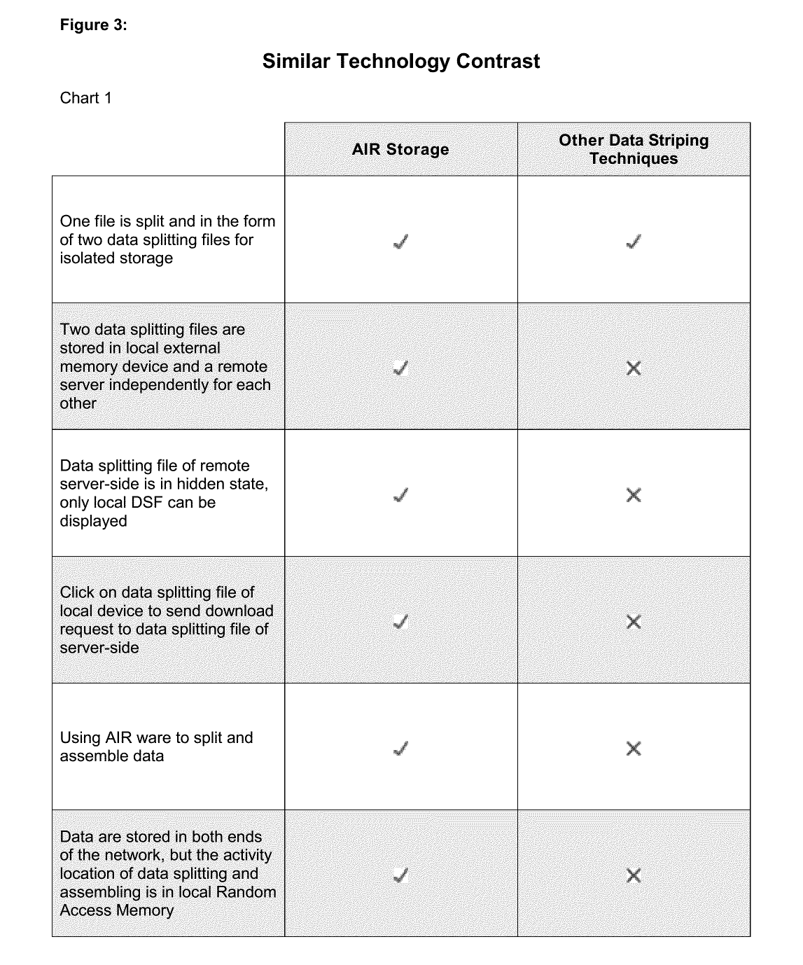

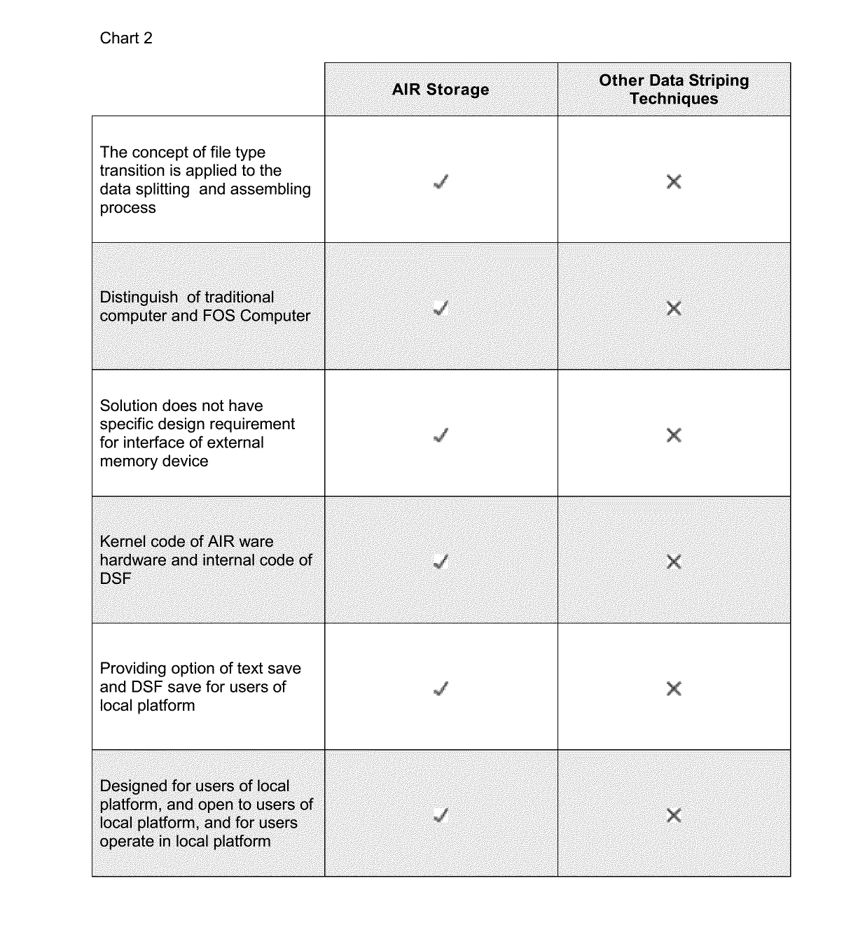

In FIG. 3: Similar technology contrast, see chart.

In FIG. 3: Different technologies have their similarities, but they also have their own applicable range and work characteristics, AIR Storage combines advantages of variety techniques will be more effective to increase the security level of the stored data.

### TECHNICAL FEATURE OF THE INVENTION

### Overview

In AIR Storage, a computer-generated file was split into two data splitting files before it is transmitted to storage medium, one of them is transmitted to a local external memory device or similar medium for storage, and another one of them is transmitted to a device of remote location through network, which comprising server, for storage.

The two of data splitting files cannot be displayed with the meaningful informative content, thus the file must go through data assemble and file recovery process by computer before user can use the file.

Actions of AIR Storage mainly include file data splitting, file directional storing, file flowing to local Random Access Memory, file data assembling, and file recovery; all this series of data regulatory actions are processed by AIR ware.

In traditional computer system, the AIR ware is installed on the local platform, which delicately belongs to AIR Storage, so the AIR Storage function has to work with AIR Ware.

In FOS Computer system, the function of AIR ware is native to the computer operating system, and the AIR Storage is part of overall function of FOS Computer.

AIR storage's features are mainly as follows:

In AIR Storage, the data of a complete file on client platform is split into two halves, and form two separate data split files, wherein one is remote data splitting file, referred to remote DSF, remote DSF stored on a device of remote location over network comprising server, and other one is local data splitting file, referred to local DSF, local DSF stored on external memory device or similar medium of client platform, wherein local means the client platform.

In AIR Storage operation, file data splitting is to implement by a method of special algorithm, which use of a special data striping computer-readable medium to achieve.

AIR Storage does not have the specific design requirement for interface of external memory device or similar medium, which different from other solutions of data splitting technology, the other solutions more or less have the design requirement for interface of external memory device or similar medium.

AIR Storage not only involves two main aspects of file data splitting and file data assembling, but also involving many other auxiliary aspects, such as restriction of direction of data transmission, and exclusion of interference of other signal in system, and setting of security measures, all of them are guided and processed by a dedicated system tool of AIR ware.

AIR ware is a processing unit of AIR storage located on client platform, its main function is to split a file into Remote DSF and Local DSF, and make Remote DSF and Local DSF lose the ability to display informative content, and send Remote DSF to a device of remote location comprising server for storage, send local DSF to local external memory device or similar medium for storage, when recovering files, AIR ware assembly data so that the file is to be recovered to complete status and be displayed on local platform.

One prominent feature of AIR Storage is that users autonomously operate their local DSF on client platform, and user does not need to consider how to pass the server identification checking and how to find another half of relevant DSF stored on server; another prominent feature of AIR Storage is that the remote DSF to be controlled by relevant local DSF.

Data splitting file is generated in local Random Access Memory.

The data splitting files are transmitted to local external storage device and a device of remote location comprising server for storage from local Random Access Memory.

Remote DSF and local DSF are integrated internal code by AIR ware, the internal code cannot be altered after generation, which belongs hidden code for system identification, not known by user, and it can be copied with local DSF.

Internal code is the code for AIR ware identifying remote DSF and local DSF, and this internal code is the identification code for two files mutual recognition between device of remote location comprising server and client platform, and is the identification code for two files assembling in Random Access Memory of client computer.

From the perspective of client platform, Remote DSF is a deep hidden file, In addition to using local DSF and its internal code, it is no way to be located and downloaded.

User click on icon of local DSF on client platform to send the command to serve for download corresponding remote DSF.

User can enter the login name and password once, and then maintain the system at login status until network exiting or computer shut down, in this case user need not repeated login to enable the process of splitting and assembling files, but users can also choose repeated logon method to enable files.

Remote DSF on server end can be re-split and stored in multiple servers, in this case, as long as the download command issued from local DSF is received by one of split part of corresponding remote DSF, other split parts will pass on download command each other and simultaneous download.

AIR ware is a specific computer program, or a combination chip of volatile and non-volatile storage medium integrating AIR storage application programs, which is a tool of splitting and assembling data, and a conversion center of file type, and a transmission channel of remote DSF and local DSF, and a security device of data splitting files.

AIR ware can be permanently installed on computer motherboard, or be made into an external device for user to carry.

As a dedicated hardware device, AIR ware has its hardware kernel code, when command sent from local DSF to network server for downloading corresponding remote DSF, AIR ware's hardware kernel code will also be sent to server for verification.

AIR ware hardware kernel code is hidden code, and it is encrypted when sending to server, and decrypted by server.

If AIR ware hardware kernel code does not match server record, the server will ask user to provide detailed identity information and other advance agreed authentication information, only server inspection passed, remote DSF download will be processed.

The local DSF of client platform must go through AIR ware before entering assembling process, the local DSF that bypassing AIR ware and directly entering Random Access Memory of client computer will lose assembling capability.

AIR ware split file data, meanwhile automatically generate internal code and integrate it in remote DSF and local DSF, only files with internal code can be accepted by AIR ware and allowed to enter AIR storage process.

All remote DSF and local DSF flowing within system must go through the channel of AIR ware, all command of download remote DSF must go through the channel of AIR ware to sent to server, all remote DSF, or download command to be sent to server will be encrypted by AIR ware, all remote DSF downloaded from server will first be encrypted by server and then be decrypted by AIR ware.

Wherein the login only program is specifically for temporary memorize user's login name and password of network account, when user initiate local DSF, one-time only enter the login information, then no matter how many times the file is initiated, user's login information is directly transmitted by AIR ware to server until computer shut down.

This transit login process is hidden and will not display on computer monitor.

After file to be assembled and full displayed on computer monitor, regardless of whether there is file modification, as long as the file is saved with AIR storage method once again, the data will be re-split and the data content of remote DSF and local DSF will be changed, then the original data splitting file will be overwritten.

AIR ware split data or split text code of files so that the file can not display informative content, but AIR ware does not have multiple splitting functionality for data or code, file is allowed to be split into two halves only, and one is remote DSF, another is local DSF.

AIR ware set up the flow track and orientation for split files, remote DSF can only flow to a device of remote location comprising server for storage, local DSF can only flow to external memory storage device of client platform for storage, wherein local DSF has operator interface icon, and remote DSF has no operator interface icon.

Users click on icon of local DSF to send download command together with the internal code of local DSF to network server, which first retrieval server address from AIR ware, and then the command and internal code is encrypted by AIR ware, and then command, internal code together with AIR ware hardware kernel code are sent to network interface card.

AIR ware listens to network interface card, if server responds, AIR ware will receive remote DSF through network interface card, decrypt and transport remote DSF to local Random Access Memory, meanwhile local DSF also to be collected through AIR ware to said Random Access Memory, and two part of data splitting files begin assembling.

That user deletes local DSF is meanwhile to sent command to server for deleting corresponding remote DSF, if network cannot be connected, AIR ware will memorize this delete command until network is connected, then AIR ware will automatically sent the deleting command to server through network interface card.

When file is recovering, the remote DSF is download from server to local platform, and combined with local DSF in local Random Access Memory to form a logical unit, so the data splitting file is converted into a complete-data file.

Data splitting and assembling platform is on client computer, and server cannot perform any operation, but this platform is not a local external storage device, because the data flow related to the CPU and network, which beyond the function of external memory device or similar medium.

Random Access Memory and external storage devices are both located on local platform, which is the interaction between two devices belonging to the same platform, so it is easy to build data processing system, and achieve data docking.

In AIR Storage, the remote DSF of server-end accepts the command of local platform, and only users are eligible to issue this command to server, and file recovery process is only done on local platform.

The local DSF and remote DSF will not be stored to their other side of medium and leave traces on the other side of medium.

Server-end store remote DSF, but remote DSF is processed and uploaded by the AIR computer-readable medium that installed on the local platform, server-end lack of specific AIR computer-readable medium, therefore cannot modify the data, and server-end lack of local DSF, even if server has AIR computer-readable medium, it is still unable to go to file recovery process.

When file data is in local Random Access Memory, there are two options for user to save their file: (1) text saving. In this case, any change of file is saved in the form of complete file, (2) security saving. In this case, the file will be automatically split into two data splitting file and overwrite the original file.

When text saving is selected, there are further two options for user to choose, which are (1) file is temporarily stored in Random Access Memory despite disappear after the computer shut down, (2) file is transferred to external memory device or similar medium, or remote server for storage, in this case the original data splitting file will be automatically deleted.

The local Random Access Memory will set aside a special area for data splitting and assembling activities, so as not to conflict with other types of data streams in system.

The two data splitting files in Random Access Memory must be successful docking, if the data cannot be effectively docking, the file will become a dead file.

When file is stored to a local external memory device or similar medium, the user can choose the save mode of whole file, or the save mode of data splitting file.

If user selects the data splitting mode, the file can only be readable in case of connecting to network.

The login information is used to prove the identity of user, in the case of pre-set password, the user click on the icon of data splitting file on local platform, the system will automatically pop-up window and ask user to enter password, and then the server will accept download instruction.

The set-up process of password is specifically designed by AIR ware for data splitting file, which is only used in the identification and connection between a pair of data splitting files.

The login password here is not the login password of user's ordinary network account, click on the local platform data splitting file, it is impossible to enter user's ordinary account.

Local DSF of local external memory device or similar medium establishes direct connection with remote DSF of server, and login password and internal code is used to confirm this connection relationship.

Under the premise of the network connection, remote DSF of server-end is downloaded on demand, if there is no command from client, there is no automatically downloading of file.

If a main file contains a number of sub-files, the main file that as a unit will be one-time downloaded, not separate download can be done.

Once the remote DSF is downloaded to local platform, it is stored in Random Access Memory, and always in the ready state waiting for the call command of system, which prevents network halfway disconnecting, and also facilitate data quick extract.

The assembled data are from two different channels, and to be processed by AIR ware, thus formed file certainly has a new file style, and the new file style cannot be identified by traditional system and cannot be normally displayed.

In this case, AIR ware will automatically generate a new file to replace the assembled file, and the file style of new file will fully adapt to the requirement of traditional system.

The newly generated files are only temporarily saved and run on the Random Access Memory, during this period, any changes made to file can be saved in the Random Access Memory.

AIR ware does not restrict the type and model of the external memory device or similar medium, as long as user chooses the Air Storage function, every kind of external storage device will work.

AIR ware does not restrict data splitting files to be stored together with other types of complete files in same external storage device, but only the data splitting file to be started, then AIR ware go to work.

Under traditional system, user can only see the icon of local DSF that stored in local external memory device or similar medium from the computer operator interface, even if the user enters his personal network account, he cannot find the remote DSF of server-end by ordinary means.

From the perspective view at local platform, the remote DSF which stored on server-end always remains hidden, if local DSF in external memory device or similar medium gets deleted by user, which will appears to be all the files gets deleted.

Under traditional computer system, the local DSF in local external memory device or similar medium can be arbitrarily transferred to ordinary personal network account, the data splitting file is no exception.

The local data splitting file that uploaded by user from local external memory device or similar medium to a remote server for storage remains the same attributes as ordinary file, and does not have the same attributes as remote data splitting file. The said uploaded local data splitting file has to be downloaded to local external memory device or similar medium first, in order to initiate AIR Storage assembling process.

### Glossary Define

1. AIR Storage

Assembling of isolated remote data, being referred to as AIR Storage, is a technology of data storage under network condition. In this technology, a data-complete file is split into two parts, and in the form of data spitting file to be stored in local external memory device or similar medium and a device of remote location through network, which mainly comprising server.

The data assembling is an activity across network, data splitting files flow to local Random Access Memory from remote server and local external memory device or similar medium, and through the process of data assembling to form a data-complete file, wherein data splitting file referred to as DSF.

DSF is isolated and shortfall data file, in absence of network condition, it will become sleep file and to be useless alone. Local DSF's corresponding part of DSF is separated by network and stored in remote server, which accept user direct instruction to download rather than automatic operating by system.

In AIR Storage, a data-complete file on client platform is split into two halves, and form two separate data split files, one is remote data splitting file, referred to remote DSF, remote DSF stored on network server or other device of remote location through network; another one is local data splitting file, referred to local DSF, local DSF stored on external memory device or similar medium of client platform, wherein local means client platform.

Remote DSF and local DSF are integrated with same internal code by AIR ware, the internal code of DSF is not to be altered after generating, and it is able to be copied together with local DSF.

In AIR Storage, data splitting and assembling platform must be on client platform, server do not perform any operation, the process of data splitting is completed and the data splitting file is generated in Random Access Memory of client platform; the process of data assembling and file recovery must also be performed in Random Access Memory of client platform.

In AIR Storage, files have four identifiers for server to recognize, they are file name, internal code of DSF, user's login information, and hardware kernel code of AIR ware, and the first three are the most basic identifiers, the last one is for reinforcement.

After file to be recovered into a data-complete one and displayed on computer monitor, regardless of whether there is file modifying, as long as file is saved with AIR storage mode again, the data will be re-split, and then data content of data splitting files will be changed, and the original data splitting file will be overwritten.

There are advantages and weakness for a data-complete file to be stored in local external memory device or similar medium, or in network server, AIR Storage not only overcome the aforementioned weaknesses, but also absorbs and enhances the advantages of local platform and server.

First, in AIR Storage, no one can get complete data information except data owner himself.

Secondly, in AIR Storage, data is stored in the form of data splitting file, thus, no matter the file to be stored in a remote server, or stored in a local hard disk, or stored in other local external memory device or similar medium, they are equally safe, so the gap between types of storage medium is narrowed.

Furthermore, in AIR storage, remote Data splitting file is controlled by local data splitting file, but the control privilege of data splitting file rests on client platform and in user's hand, so only file owner is entitled to recover files.

2. Data Splitting File

In AIR Storage, the data splitting file is referred to as DSF.

AIR ware split data to make file lose ability to display informative content, and file is only to be split into two halves, one is remote DSF, and another is local DSF.

AIR ware set the track for flowing of data splitting file, remote DSF flow to server for storage, local DSF flow to external memory device or similar medium of client platform for storage, wherein local DSF has interface icon, remote DSF has no interface icon.

Data splitting file is characterized that if complete informative content of file need to be displayed, which requires network connectivity, and requires AIR ware, and requires assembling feature of splitting data to work.

Data splitting file can be converted into a data-complete file according to user's selection, and then to be stored in external memory device or similar medium, or stored to remote server.

If user wants to re-convert data-complete file to data splitting file, AIR ware will reproduce data splitting files for local platform and remote server, the new files will have AIR Storage characteristics.

The design of such procedure is to avoid chaotic system identification, and to prevent files in external memory device or similar medium to be stolen.

(1) Local DSF:

In AIR Storage mode, the data splitting file stored in local external memory device or similar medium is known as the Local DSF.

AIR Storage does not have special design requirement for interface of external memory device or similar medium, it is different from some of other data striping technology, which more or less have design requirement for interface of external memory device or similar medium.

When file is stored in local external memory device or similar medium, user can choose data-complete file storage, or data splitting file storage, if user selects data splitting mode, the file can only be activated in case of network connecting.

Under traditional computer model, the independent function of local device, the interaction between traditional local platform and server platform, and the interaction between local external memory and Random Access Memory are all the foundation of running of AIR Storage, the data splitting file is same as data-complete file that completely obeys traditional rule, and largely rely on traditional means to resolve operation problem.

If traditional means cannot work, the means of AIR Storage can be used for replacement, for example, using traditional copy function to copy data splitting files may pose a security risk, which could be replaced by the copy function of AIR ware, because AIR ware set targeted security mechanism for file copy.

AIR Storage has a feature that local DSF control remote DSF, and user autonomously operate local DSF on client platform, wherein user clicks icon of local DSF on client platform to send command to serve for download corresponding remote DSF.

In case of network broken, the data splitting file stored in external memory device or similar medium is a sleep file, and no meaningful informative content can be displayed.

Local DSF can be copied between different local external memory device or similar mediums, also be multiple backups in some external memory device or similar mediums, such as hard disk RAID1, in order to prevent data to be loss, and enhance device operation speed.

Local DSF is not activated in poor network connection or poor network transmission, because in this case the remote DSF is not downloaded from server to local Random Access Memory.

(2) Remote DSF:

Remote DSF is the data splitting file that stored on remote server.

In AIR storage, a data-complete file is split into two data splitting files, one to be uploaded to remote server for storage, another to be locally stored in external memory device or similar medium.

The remote DSF is hidden, and undetectable by ordinary means, and client platform displays only files in external memory device or similar medium.

Remote DSF is a deep hidden file, if lack of specialized methods, it is not displayed on server and client platform independently, not known to user, and nor to be found trace in server end by ordinary technical means, in addition to using local DSF and its internal code, there are no ways to locate and download it.

In local Random Access Memory, after file is split, local DSF can only be input to external memory device or similar medium, and remote DSF can only upload to remote server, so only files in external memory device or similar medium can be displayed.

For this reason, remote DSF of server-end cannot be transferred to local external memory device or similar medium for backup, because local platform cannot see the traces of server-end data splitting file, so it is impossible to specifically download.

The data splitting file of local platform have no difference with data-complete file in appearance except it cannot be activated individually, it directly connect remote DSF, user at any time request to activate it, just click on file icon on computer operator interface, and which is also to sent command to remote server for requesting download corresponding remote DSF.

Under the premise of network connection, the data splitting file of server-end is downloaded on demand, there is no command from client, and there is no automatic download for files, which is to prevent excessive network busy caused by automatic download, but also to prevent unwanted data to occupy resource of local Random Access Memory.

Once remote DSF download to local platform already, it is stored in Random Access Memory, and always in ready state waiting for call command of system, which prevents halfway network broken, and facilitates data quick extract.

Remote DSF downloaded from remote server to local platform is confined to be in Random Access Memory, it is not allowed to transfer to local external memory device or similar medium, and for the physical characteristics of Random Access Memory, said files will automatically disappear after computer shutdown.

The download command sent from local DSF to server, server might ask user to enter login name and password in accordance with pre-set, but it is optional.

In the case of using a dedicated hardware device, user login information and AIR ware kernel code of hardware are essential part of server check information, information does not comply with original record of server, server will refuse the download of corresponding remote DSF.

Remote DSF on server end can be re-split and stored separately in a group of multiple servers by system, in this case, as long as the download command issued from local DSF is received by a splitting part of corresponding remote DSF, other splitting parts will pass on command each other and simultaneous download.

Remote DSF must accept the commands from local platform, data-assembling process is only done in the local platform, and only user has privilege to issue command to server.

3. Data Assembling

The data assembling is an activity that DSF to be collected both from remote server and local external memory device or similar medium by AIR ware, and by a method of data assembling to recover original data-complete file in local Random Access Memory.

In FOS Computer, operator interface of local computer does not automatically display icon of local DSF, only external memory device or similar medium is activated, file icon can be displayed on interface, because there are maybe no hard drive on client computer.

Remote DSF of server-end always remains hidden state, which is controlled by client platform; for interaction between client platform and remote server, the client platform occupies active position, and server-end occupies passive position.

User clicks on local DSF that stored in local device, which is equivalent to click on remote DSF that stored in remote server, then both ends of file will be activated one after another.

In poor network connection or poor network transmission, remote DSF of server-end sometimes cannot be downloaded to local Random Access Memory, in this case, local DSF cannot be activated.

Local DSF and remote DSF establish direct connection through network, and internal code of DSF is the connective bridge between two related DSF.

Local DSF of client platform must go through AIR ware before entering assembling procedure, if it bypasses AIR ware to directly enter Random Access Memory, it will lose capability of data assembling.

In data assembling process, AIR ware will automatically generate a new file to replace assembled file, the file style of new file will fully adapt to the requirement of system; the newly generated file is only temporarily saved and operating in Random Access Memory, during this period, any changes made to file can be saved in Random Access Memory.

Remote DSF is downloaded to local platform and assembled with local DSF to form a logical unit, then the data splitting file convert into a data-complete file, AIR ware use special algorithms to achieve the effectiveness of data assembling and file recovery.

The two of data splitting files are only to be successful assembled in Random Access Memory, then the informative content of file can be displayed, if data assembling failed, users need to exit the data assembly process, and from file recovery request to start again to enter a new round of data assembling; attempt repeatedly fail, which could mean one DSF or two related DSF have become real “bad file”.

4. Implementation Platform

A data-complete file is collected into local Random Access Memory for splitting process, data splitting files are from storage devices of both ends of network to be collected into local Random Access Memory for assembling process, in the AIR Storage, local Random Access Memory acts as a central data sink, data splitting and assembling are completed in there.

The most direct effect brought about is that users no longer need to worry about files being leaked during transmission in network or directly being leaked on server. Client platform close to user, which facilitate to implement user's control privileges, then data processing to be limited in local Random Access Memory, which avoid operation traces to be left on client platform and be used by others, but also ruled out spy ware factors of hard drive, and strengthen user's exclusive status on their files.

Data striping is a common technology now, but the work of this technology are automatically running within computer system, or running on network server, or running on client platform, there is no functionality for the work to across network, nor is the work directly operated by user, which is different from AIR Storage.

In addition, there is another important difference: Data striping process to be completed usually requires the participation of the hard drives with special configuration and port, or other similar external storage devices, such as RAID, but for AIR Storage, data splitting and assembly process are completed in local Random Access Memory, which is totally unnecessary for special hard drives or other external storage devices to participate.

The data of same text is spitted into two halves, so the text will not be able to be completely shaped, and the file lost informative meaning.

The action of file data splitting is carried out in the local memory Random Access Memory, because Memory Random Access Memory have the characteristics of temporary storage, after the computer is powered off, all the data that not being stored in external memory device or similar medium will be lost.

Local DSF is confined to be stored in external memory device or similar medium of local platform, and remote DSF is confined to be stored on server, the two files will not be stored to the other side of the medium.

In data assembling process, local DSF that stored in external memory device or similar medium is collected into Random Access Memory, and with certain algorithm to implement data assembling with remote DSF, so as to display full content of file.

Remote DSF is stored in remote server, but this file is processed and uploaded by the AIR ware that installed in local platform; server-end cannot modify the uploaded data, and server end do not have other corresponding half of splitting data, thus it is impossible for server to assembling file.

Data splitting and assembling platform must be in client platform, and server does not perform any operation; the platform is not a local external memory device or similar medium also, the right place of data splitting and assembling is Random Access Memory of client platform.

The external memory device or similar medium has data splitting file, the Random Access Memory has data splitting file downloaded from server, as long as assembling these two parts successfully, and file-recovering process is finished.

5. File Saving on Client Computer

FOS Computer is another invention of same inventor, and its most important feature is that the computer operating system to be spitted into two portions, wherein the main portion is installed on a remote server, and to be downloaded to local platform of Random Access Memory to run as needed.

FOS Computer has a new hardware device of OSPU, which integrates basic data of operating system.

In traditional computer system, most of data that stored in local external memory device or similar medium is operating system, but under FOS Computer system, the external memory device or similar medium is no longer the carrier of operating system, which is only the common data storage device.

Regardless of application in traditional system, or application in FOS Computer system, AIR Storage needs to use physical characteristic of Random Access Memory, which are reflected in following aspects:

(1) Data splitting file is generated in Random Access Memory.

(2) Data splitting files are separately transmitted from local Random Access Memory to both of local external memory device or similar medium and remote server for storage.

(3) The remote DSF that cannot be timely transferred to server by system will be temporarily stored in Random Access Memory, as long as computer does not shut down, it will continue to work.

(4) Data splitting files need to be transferred from external memory device or similar medium and remote server to Random Access memory, and data-assembling action is to be completed in local Random Access Memory.

(5) While data being successfully assembled, the new data-complete file is temporarily stored in local Random Access Memory, and if there is no command of transferring to other medium, it will disappear after computer shutdown, then data splitting file will restore original state.

There are two options for user to save file when file stay in local Random Access Memory, which are:

(1) Text Saving. In this case, any change on file is saved, and saved in the form of data-complete file.

(2) DSF Saving. In this case, the data-complete file will be automatically split into two data splitting files and original user generated files will be overwritten.

In case of text saving to be selected, there are further two options for user to choose, which are:

(1) Temporarily stored in Random Access Memory until disappear after computer shut down.

(2) Transferred to external memory device or similar medium, or a remote server for storage.

Random Access Memory of client computer set aside a special area for data splitting and assembling, so as not to conflict with other types of data streams in system.

The two data splitting files in Random Access Memory must be successful assembling, if the data do not effectively assembling, the file will become a dead file.

When user selects DSF save mode, file is only activated in case of network connected.

The data splitting file can be converted into data-complete file and to be stored in external memory device or similar medium or remote server according to user's selection.

After file type to be changed to normal, data-complete file is freely transmitted and displayed, no longer subject to constraints of AIR Storage rules.

After file type to be changed to normal and data-complete file to be saved, the original local DSF and remote DSF should be deleted or by system automatically, or by manual operation, this process is not reversed.

In case of user wants to re-convert data-complete file to data splitting file, AIR ware reproduce data splitting files for both of local platform and remote server to store, and the new file have characteristics of AIR Storage.

AIR ware provides write-protect function, if user set up write-protect, system will refuse file to be repeat save and modify, in this case, data content of local DSF will maintain long-term stability, and is suitable for long-term data backup.

6. AIR Ware

AIR ware is a processing unit of AIR storage that located on client platform, its main function is to split a data-complete file into remote DSF and local DSF, and make remote DSF and local DSF lose ability of displaying informative content, then sent remote DSF to server for storage, sent local DSF to local external memory device or similar medium for storage, when user give instruction of file recovering, AIR ware will collect DSF from both end of network, and to assemble data on client platform, so that the file is recovered to data-complete state, and then able to be displayed on local platform.

The AIR ware has two definition, they are 1, a specific computer application program, 2, a dedicated computer hardware devices; as a special computer application program, AIR ware is installed on the external memory device or similar medium of variety of different local platforms, including hard disk and flash memory device, etc, for implementing all functions AIR storage.

As dedicated computer hardware devices, AIR ware is a chip integrated with AIR storage application, which is a data processing component for splitting and assembling data, a conversion center for file type, a transmission channel for remote DSF and local DSF, and a security component for data splitting files.

AIR ware can be permanently installed on computer motherboard, or be made into an external device for user to carry, also it can be made a portfolio device that combine some mobile electronic devices, such as portable external storage device, cell phone, electronic watch and others.

In process of data transmission, hardware information of AIR ware is added in security measures, which can overcome the shortcoming of software's code, which is vulnerable to modification; furthermore, even if local DSF is stolen, people are unable to use it, because there is no original hardware kernel code in another AIR ware, and third party usually cannot pass stringent user identification checking by server.

All remote DSF and local DSF must be through AIR ware channel to flow to their destination, all user command must be through AIR ware channel to sent to remote server, all uploaded command is encrypted by AIR ware, all remote DSF downloaded is first encrypted by server and then decrypted by AIR ware.

(1) AIR Ware Basic Working Principle

AIR Storage not only involving two main aspects of file data splitting and file data assembling, but also involving many other auxiliary aspects, such as setting up security measures, which requires a dedicated computer component to guide and processing data.

This computer component is a specially designed hardware, or specific application program, which is called AIR ware. AIR ware is installed on local platform to implement full functionality of AIR Storage.

In traditional computer system, AIR ware is a stand-alone computer component, and it can be independently run under the operating system that carried by local hard drive.

In FOS Computer system, the function of AIR ware is integrated in OSPU.

When user chooses Air Storage function, the AIR ware will automatically split a data-complete file into two parts, and one part to be transmitted to external memory device or similar medium and another part to be transmitted to remote server.

AIR ware generates the same internal code for two data splitting files, but file icon of client platform is only connected to local DSF.

AIR ware will strictly restrict two data splitting files flowing into same storage channel.

When user want data-complete file, AIR ware is through network connector to sent user instruction to remote server, and then guides remote data splitting files that downloaded from server into local Random Access Memory, meantime AIR ware guides local data splitting file from local external memory device or similar medium to the local Random Access Memory.

AIR ware use special algorithms to successfully assemble split data, and then file recover completely.

The assembled data are from two different channels, and by AIR ware processing, thus formed file is certainly given a new file style, and new file style or unable to be identified by system and unable to be normally displayed.

In this case, AIR ware will automatically generate a new file to replace the assembled one; the file style of new file will fully adapt to the requirement of traditional system and become displayable by system.

The newly generated file can only be temporarily saved and run on local Random Access Memory, any modification of file can be saved in Random Access Memory, in this case user can choose DSF save, then AIR ware will re-split data for new file, and new data splitting file will overwrite the original file.

(2) Hardware Kernel Code of AIR Ware

As a chip device, AIR ware has its hardware kernel code, when command sent from local DSF to network server for downloading corresponding remote DSF, hardware kernel code of AIR ware is also sent to server for verification.

AIR ware hardware kernel code is hidden code, and it is encrypted by AIR ware when sending to server, and decrypted by server.

If AIR ware hardware kernel code do not match server record, server will simply refuse to accept commands from said AIR ware, or ask user to provide detailed identity information and other advance agreed authentication information, only server inspection passed, server will allow user to replace AIR ware, then the user is allowed to adopt a new AIR ware hardware kernel code to send commands, and remote DSF download will be processed.

An main piece of AIR ware is allowed to pre-configure several auxiliary pieces as backup, these auxiliary pieces of AIR ware is only authorized by main piece of AIR ware, and to be pre-recorded on server, their AIR ware hardware kernel code can be activated, then to be working simultaneously with the main piece of AIR ware, but when network to be logged in, the other login information of main piece and auxiliary piece of AIR ware, such as user personal information, password and internal code of DSF must be consistent.

(3) Code Generator of AIR Ware

The non-volatile storage medium of AIR ware integrated the program of code generator, which mainly used to generate internal code of DSF file and user random login password, the non-volatile storage medium of AIR ware is a sealed structure, therein the programs is to be pre-integrated and permanent integrated, which does not allow users to self-install program and not allow data within non-volatile storage medium of AIR ware to be modified.

AIR ware split file data, meanwhile automatically generates internal code and integrate it in remote DSF and local DSF, then only files with internal code can be accepted by AIR ware and allowed to enter AIR storage procedure.

When data-splitting file is generated, the AIR ware will give users two options, (1) Set up a login password, (2) provide a login password.

Once login password to be pre-set, the password will be saved on server for verification purpose, each time user using splitting data file, he should first enter the login password.

In case of user selects “provide a login password”, when user clicks local DSF file, the program of password generator integrated in AIR ware chip will randomly generated a time-limit-use password, and the password will be sent to the user pre-assigned ordinary network account through network and server, and then user enter the password required by system to actuate DSF file.

(4) Login-Only Memory of AIR Ware

The volatile storage medium of AIR ware integrated a login only program with memory function, which provides users with another option, user do not need to repeatedly login server himself, and the system does not need to be always in login status.

The transit login process of login-only memory is hidden and will not display on computer monitor.

Wherein the login only program is specifically for temporary memory of user's login name and password, when user activate local DSF, one-time only enter the login information, then no matter how many times file is activated, user's login information is directly transmitted by AIR ware to server until computer shut down.

Command upload from local DSF to server, user's login name and password are the essential part for server information check, any information does not comply with original records of server, server will refuse the command for download of corresponding remote DSF.

If AIR ware permanently mounted on computer motherboard, once host computer is stolen, data splitting file will be in risk of data assembling through network, so it is necessary to design network login procedure to prevent such risk.

Users can also choose repeated logon method to enable file.

AIR ware integrated login-only memory, which provides users another option, user do not need to repeatedly login server himself, and system does not need to be always in login status.

As the physical characteristics of memory, once power supply of AIR ware is interrupted, user login information in login-only memory all at once disappears.

The data channel of login-only memory is restricted, it is only for temporary storage of user login information, and any other data is denied access to memory.

AIR ware login-only memory and AIR ware kernel code used in combination will make the use of data splitting file easier and safer.

(5) Network Contact of AIR Ware

Remote DSF flow to server for storage only, and local DSF flow to external memory device or similar medium of client platform for storage only, AIR ware limit the mutual dislocation flow between them through programming, wherein local DSF has interface icon, remote DSF has no interface icon.

User click the icon of local DSF to send command, meanwhile to send the file internal code of local DSF to network server, but before which, system has to retrieval server address from AIR ware, and encrypt command and internal code by AIR ware, and then command and internal code together with hardware kernel code of AIR ware are sent to network interface card.

After command for downloading to be sent from local DSF to server by user, the server will ask user to enter login name and password of user's personal network account. User's login information is combined AIR ware kernel code during network transmission, both are the essential part of server check information, any information thereof does not comply with original records of server, server refuse the command of downloading of corresponding remote DSF.

The personal network account described here is the dedicated account for AIR Storage, which is not the ordinary network user account for user everyday use.

AIR ware listens to port of network interface card, if server responds, AIR ware receive remote DSF through network interface card, decrypt and transmit the downloaded remote DSF to Random Access Memory, meanwhile local DSF to be collected through AIR ware to Random Access Memory, and two parts of data splitting files start assembling.

When user deletes local DSF and sent server a command to delete corresponding remote DSF, if network is not connected, AIR ware will memorize deleting command until network is connected, then AIR ware automatically sent the deleting command through network interface card to server.

7. Internal Code of Data Splitting File

AIR ware split file data, meanwhile automatically generates internal code for remote DSF and local DSF, then only files with internal code can be accepted by AIR ware and allowed to enter AIR storage procedure.

Internal code of DSF cannot be altered after generating, it belongs to hidden code only for system identification, and not known to user, internal code of DSF can be copied together with local DSF.

(1) Internal Code of DSF in Data Assembling

Internal code is the code for AIR ware to identify DSF, and is the code for remote DSF and local DSF mutual recognize between server and client platform, and is the code for determining the two files to be capable of assembled in Random Access Memory of client computer.

Remote DSF is a deep hidden file in server-end, it is not displayed on server and client platform independently, and nor to be found trace in server end by ordinary technical means. In addition to using local DSF and its internal code, it is no way to be located and downloaded.

User click on icon of local DSF on client platform to send command to serve for download corresponding remote DSF.

(2) Internal Code of DSF in Deleting File

In addition to the action in process of data assembling, internal code also acts in process of deleting files.

From local platform to view, remote DSF of server-end always remains hidden, so deleting local DSF in external memory device or similar medium is seems to delete all files.

External memory device or similar medium does not prohibit any file to be deleted, and will not default condition for file deleting, so local DSF may be deleted in the case of network broken, in this case, remote DSF of server end maybe become junk files permanently and accumulate in server's storage device.

In FOS Computer system, file-deleting mechanism as complete program is assembled in operating system, therefore the solutions given here is mainly for traditional computer system.

The data-complete file in Random Access Memory is processed by AIR ware and is split into two data splitting files, at same time the AIR ware assign an internal code to data splitting files as the system identifier; when file is to be deleted, user simply delete local DSF, the internal code of local DSF also to be deleted, then this deleting action of internal code of local DSF is transformed into command of deleting corresponding remote DSF, and to be sent to server in a timely manner.

In case of network unable to be connected, AIR ware will memorize this deleting command until network is connected. Once network is connected, AIR ware will automatically sent server the deleting command through network interface card, and then server automatically deletes the corresponding remote DSF according to internal code of DSF.

The pending procedure of deleting command applies to both of original file and copied file.

(3) Internal Code in the Copied File

Internal code of DSF is a code that can be copied, and therefore copied files can still be recognized by system.

Original file can directly connect server, copied file can also directly connect server, and they all require user personal login information and AIR ware information for server to authenticate.

Copied file in traditional system has the same right of original file to modify file.

In AIR ware, there are two options for user to process the copied file: (1) modification not allowed; (2) modification allowed.

If user selects “modification not allowed”, once file is modified and asked to save, new file will be subjected to re-splitting by AIR ware, and in the form of new data splitting file to store, in this case, the new data splitting file does not overwrite the original data splitting file.

If user selects “modification allowed”, and the copied file to be recovers to data-complete file, and to be modified, then the original file will be overwritten, or delete.

8. AIR Storage Under Different Computer System

The design of AIR Storage has taken into account the variety of computer system operating rules, as long as AIR ware is installed in client computer, it will follow all the operating rules of traditional system.

Meanwhile, it will be subject to the impact of certain defects of traditional system.

For example, the operating system of the computer is permanent installed on local external memory device or similar medium, which makes external memory device or similar medium become attack focus of computer virus, and local DSF stored in such devices is surely to be suffering from this threat.

Another example, AIR Storage follow operating rules of traditional system, which do not restrict the action of file copy, file cut and file paste between external memory device or similar medium, also do not restrict mutual file transferring between external memory device or similar medium and remote server; the system running rely on computer written program to guide, computer written program vulnerable to human tampering, which is the security weak point that the attack focus of virus and hacker will change to stealing DSF stored in local external memory device or similar medium and remote server.

Client platform can be freely installed application software, which also leaves room to illegal software of assembling DSF data.

So, AIR Storage is more suitable for FOS Computer System.

FOS Computer is a new computer mechanism, its operating system and applications is a new design, and wherein Air Storage functionality and security measures are detailed reflected in system design.

First, FOS Computer does not allow application software to be freely installed on client platform, application should be downloaded from server, and are subject to stringent safety testing, thus, virus and hacker lost chance to use application to stir up trouble.

Under FOS Computer, AIR ware has been permanent integrated into basic FOS (flexible operating system), which is impossible to be maliciously modified for illegal purpose; external memory device or similar medium of client platform do not host operating system, so that it is no longer the major attack target of virus and hacker, which indirectly enhance the security of data splitting file.

Second, OSPU of FOS Computer will strengthen the check of encrypted hardware identification code in data network transmission, which is more effective than relying on user name and password, or other software encryption methods.

Furthermore, in FOS Computer system, network activity becomes main computer activity, and network storage is main data storage. Data generated on client platform will be automatically uploaded to remote server for storage, but the uploaded data does not include local DSF, because it is required to be stored in client platform.

In FOS Computer system, the role of local external memory device or similar medium has been greatly weakened, and thus AIR Storage may be more meaningful under FOS Computer mechanism.

9. Remote DSF on Server

Remote DSF is in hidden state, therefore, file activation is started on client platform, but client platform cannot replace server's security mechanism. AIR ware setups a series of network security measures to meet server's security requirement.

If user clicks on local DSF to directly download remote DSF without any verification procedure, server end will be in security risks, because external memory device or similar medium may fall into third party's hand.

Login information and hardware kernel code of AIR ware effectively eliminates the hidden risk, as long as login information cannot submit by others, and AIR ware kernel code does not match server record, file in external memory device or similar medium is ineffective.

In traditional computer, the file in local external memory device or similar medium can be arbitrarily transferred to network account, DSF is also no exception, but if this process bypasses AIR ware and lack of support of AIR ware, which does not belong to the process of AIR Storage, and file lose all features of AIR Storage, and it is only governed by traditional rule.

AIR ware is mounted on client platform, all instructions are issued from client platform, and remote server is an assistant platform, which only passively accepts instruction.

However, server is also a computer device, and it can also use data striping techniques to process the saved data, but these data striping techniques running on server, compare with AIR Storage running on local platform, there is no junction point for them.

In AIR Storage, only remote DSF to be sent to remote server, and remote DSF is pre-set downloadable to local Random Access Memory only, so even if other data striping techniques to be used on server, it is impossible for server going to AIR storage process.

Remote DSF can be split and separately stored into other network servers for data backup, but which is a server system automatic function, no need user's authorization, so which does not belong to AIR Storage, because AIR storage have the feature of user autonomous operation.

In AIR Storage, server is a data storage device of remote location, and server is completely lack of user autonomy of data splitting and assembling. In AIR Storage, solution is designed for users of local platform, human-computer Interacted is between users and local platform, and solution is for user's operating on local platform.

### Inventive Step

In current technology, if a user data is stored on a network server, there is hidden risk for the user to lose control of the data, however if the user data is stored on a external memory device or similar medium of a client, there is threat of malicious stolen.

AIR Storage is precisely the technical solution to eliminate this embarrassing situation about user data storage.

(1) Improvement in Data Security by Using AIR Storage

Computers are increasingly becoming tools that people rely on in daily affairs, which produces a large number of user data every day. These user data usually are stored either on an external memory device or similar mediums of the client computer, or stored on a network server, but no matter where these data are stored in, are difficult to remove user's concern about security of their stored data.

For this reason, IT professionals continuously design security measures to protect stored data, but these measures have been always following the traditional design ideas, and hard to get fundamental breakthrough on effectiveness. Users hesitate to accept cloud storage service, and they still mainly rely on local external storage device to store their data.

Today's data security measures exist obvious limitations:

First, these measures are based on where and how to store data in order to achieve protection of data, and protection are always eyes on complete data (normal files), but there are never measures that looking deep into internal structure of data, and thinking about splitting data into two halves then store them separately to at least two distance platforms;

Second, these measures are either completely focus on client platform, or completely focus on server, they are usually only focus on one end of network, and rare with measures simultaneously using two platforms and network processes to ensure security of the stored data;

Again, these measures use hardware or use software program to implement data security features, and rare with security measures to combine hardware information and software programs into one;

Moreover, these measures are usually implementing automatically by system in accordance with the design of program, without user participation, more rarely allows users to independently manipulate the process of whole operation;

The advantages of AIR Storage is to overcome above three limitations of traditional security measures on data storage, and utilizes DSF to achieve the desired situation of data security, the gist of which is to consciously transform a normal file into a “bad file”.

“Bad file” is the phenomenon that people always want to put an end to, but in AIR Storage, the form of a “bad file” is actively used as a means to provide protection for stored data.

AIR Storage, such method for providing security to stored data is without precedent, and the effect of data security is bound to be greatly enhanced.

(2) Demand Basis of AIR Storage

The major bottleneck for network storage service encountered is the user confidence in network security.

In order to overcome this bottleneck, in AIR Storage, a complete data file is split into two halves, one halve is stored on a local external memory device or similar medium, and the other halve is stored on a remote server. Each of these splitting halves are lack of structure to form a viewable data, therefore lacking of informative content, and by storing both of the halves in two different locations can greatly reduces the chance of both halves being obtained and unintentionally recover to the original data. This attribute of AIR Storage will gives user more confidence in the security of storing data to a remote location through network.

In AIR Storage, the remote DSF stored on server must receive the command from local DSF on client device to initiate data recovery process, server alone cannot perform any data recovery operation for the stored data splitting file. Data recovery process is only done on local platform, and only that the user passed server identification process is qualified to receive the corresponding remote DSF from server, this greatly increases the security level of the stored data.

Meanwhile AIR Storage offers a security solution that gives the data original creator a chance to control the accessibility of the data while the data is stored on a remote server, and avoiding the complete data being unintentionally viewable on the remote server.

In AIR Storage, even if the local external memory device or similar medium is maliciously misappropriated by others, there are still no need to worry about the leaking of informative data, because no local DSF is viewable without getting remote DFS from server, and however, remote DFS requires identification from data creator.

AIR Storage also can improve system performance significantly, because the occupied capacity for local external memory device or similar medium to store data splitting file is only half of the original size of the data, which allows more space can be occupied to store other data, in term increasing performance of the device; the occupied capacity for server storing the data splitting file is also half of the original size of the data, and thus due to the reduction in data size, this will help improve network transmission speed of the data, and reduce server load during data transmission over network.

For a long time, IT professionals strive to improve the methods of data storage, however, the direction of these efforts or limited to local storage, or limited to the network storage. AIR Storage is to get rid of the limitations of location, which want combine the local storage and network storage together, which is bound to meet more user's demands.

(3) Technical Highlights of AIR Storage

Air Storage operating process contains at least three basic parts, the first part is to create data splitting files, and the second part is to store data splitting files, and the third part is to assembly data splitting files when the original user generated file is needed.

Data striping and data integration have been applied in the practice of IT technology, which uses a special computer program to achieve their goals, typical application examples are RAID disks.

Multiple disks in RAID side by side to form a large disk storing data, the data is split according to the number of disks, and stored into a plurality of different disks, and when the data is needed to be used, the splitting data according to certain algorithms to be integrate together.

In RAID data striping, data is divided into different segments and to be stored in different disk, its aim is to improve the operating speed of the external memory device or similar medium, and to prevent the loss of data when the disk of the device is damaged.

External memory device or similar medium is the most basic storage tool in the traditional computer system, and now, with the development of network technology, the IT field began to pay more attention to cloud storage.

Cloud storage breakthrough the limit of the local external memory device or similar mediums by improving the freedom of computer storage, but its security is always a challenging problem, and so far there is no well-recognized solution which its effectiveness has been proved most.

Professionals create the new concept of public cloud, private cloud, as well as family cloud, however these solutions are using the way of narrowing the scope of the cloud storage in exchange for the increase of security of cloud storage, which led to the repeated consumption of resource. Due to this poor exchanging behavior, three solutions mentioned above only actually gradually leading data storage back to the local storage era.

The purpose of AIR Storage is to prevent data to be stolen, its foothold is completely different from RAID, but AIR Storage realizes the knowledge of data striping and data integrating used in RAID.

AIR Storage mainly reflected the interaction between the two devices in the local platform, which are Random Access Memory and external memory device or similar medium.

Data splitting process is done in the local devices of Random Access Memory.

In the data recovery process, remote DSF is downloaded from a remote server to the local Random Access Memory, and local DSF is stored in the local external memory device or similar medium, this method is similar to that the data of RAID is dispersedly written on multiple hard disks.

The data striping and storing method is the technical concept of Air Storage, and the local external memory device or similar medium and remote server are the platforms for AIR Storage to function.

AIR Storage and cloud storage are using the network for data storage, the difference is that cloud storage completely rely on a network server, there is no client platform involved in the sharing process, but AIR Storage take advantage of both of network platform and local platform to operate, and the initiative lies on local platform.

In Air Storage, data splitting file does not have the informative significance, which is useless to be obtained from either end of the storage medium. To view the complete data file, both local storage medium and network storage medium have to working together, this is the biggest difference between AIR Storage and cloud storage.

### Implementation of Invention

There are six elements involved during the operation of AIR Storage, namely: user generated file, AIR Ware, local data splitting file, remote data splitting file, client computer, and server. Among them, the local data splitting file and the remote data splitting file are generated by the operation of AIR Ware from the user generated file, wherein the local data splitting file is further on stored in the client computer, and the remote data splitting file is further stored on the server.

AIR Ware is a specific application program, or a combination chips of volatile and non-volatile storage medium integrating AIR storage application programs. AIR Ware is the tool of splitting and assembling data, and a conversion center of file type, and a transmission channel of remote DSF and local DSF, and a security device of data splitting files.

### Implementation of AIR Storage DSF Saving Process

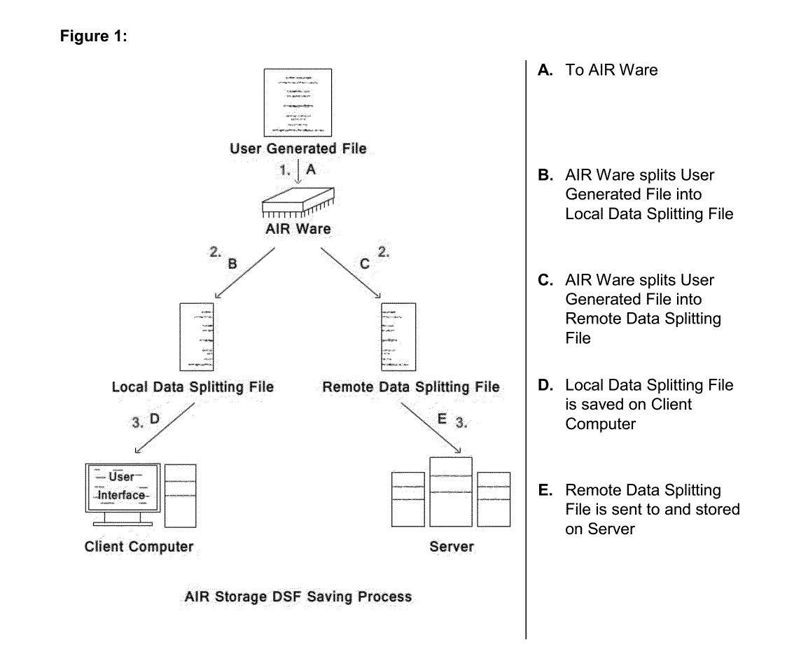

(See FIG. 1)

A Client Computer user sends a request to save a User Generated File, this file saving request will be processed by AIR Ware (A of FIG. 1). After AIR Ware receives the file saving request, AIR Ware splits the User Generated File into Local Data Splitting File (B of FIG. 1) and Remote Data Splitting File (C of FIG. 1), both Splitting Files are temporarily stored in Random Access Memory on Client Computer, simultaneously AIR Ware generates an internal code as file identifier and integrate this code into the two Splitting Files. The Client Computer though a network interface card then tries to connect Server providing AIR Storage service, in this case, there are two attempt results will to be: successful connecting and connecting failed.

1. Successful Connecting: Client Computer sends Remote Data Splitting File with internal code to Server through AIR Ware, meanwhile, Client Computer sends hardware kernel code of AIR Ware to Server through AIR Ware.

Server receives the Remote Data Slitting File with internal code and hardware kernel code of AIR Ware. Upon receiving successfulness, Server confirms the hardware kernel code of AIR Ware. After the hardware kernel code of AIR Ware to be successfully confirmed, Server stores the received Remote Data Splitting File with internal code (E of FIG. 1), and sends a message to Client Computer about data successfully saved.

After Client Computer receives the message of data successfully saved, AIR Ware deletes the Remote Data Splitting File in Random Access Memory on Client Computer, and stores Local Data Splitting File with internal code to an external device on Client Computer (D of FIG. 1).

AIR Ware then deletes the Local Data Splitting File in Random Access Memory on Client Computer.

2. Connecting Failed: AIR Ware displays a message about connection failure on Client Computer, meanwhile, AIR Ware assembles the two Data Splitting Files to restore the User Generated File on Client Computer. AIR Ware then deletes the two Data Splitting Files in Random Access Memory on Client Computer.

### Implementation of AIR Storage DSF Assembling Process

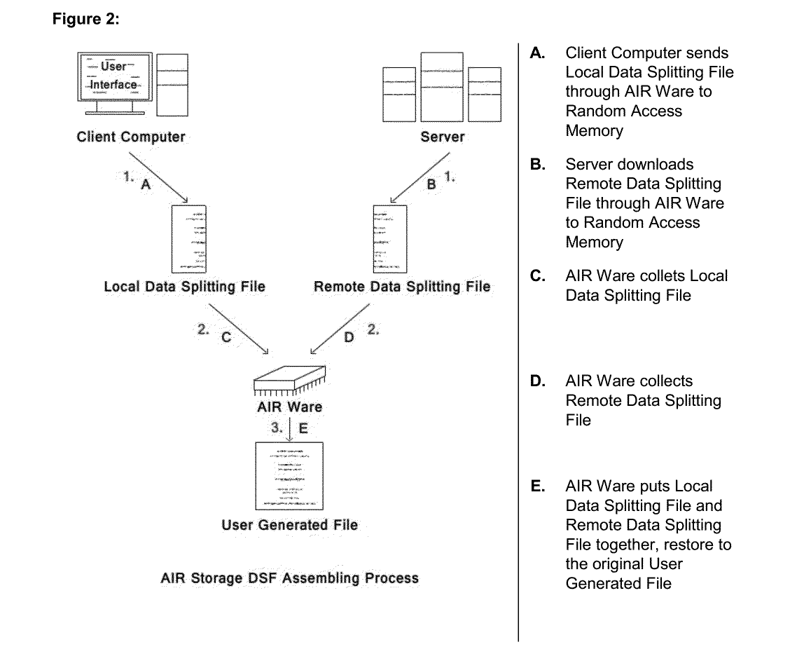

### (See FIG. 2)

When User Generated File needs to be used, user executes Local Data Splitting File on Client Computer (A of FIG. 2). AIR Ware reads the internal code within the Local Data Splitting File. Upon internal code reading successfulness, Client Computer then tries to connect Server providing AIR Storage service though a network interface card, in this case, there are two attempt results will to be: successful connecting and connecting failed.

1. Successful Connecting: Client Computer sends internal code read by AIR Ware to Server through a network interface card.

Server receives the sent internal code of the Local Data Splitting File, and tries to match internal code of a Remote Data Splitting File stored on server with the received internal code. Upon internal code matching successfulness, Server sends the Remote Data Splitting File (B of FIG. 2) having the same internal code as the received internal code to Random Access Memory on Client Computer, and sends a message about Remote Data Splitting File successfully downloaded to AIR Ware on Client Computer.

After AIR Ware receives the message about Remote Data Splitting File successfully downloaded, Client Computer transfers Local Data Splitting File to Random Access Memory on Client Computer.

AIR Ware assembles Local Data Splitting File (C of FIG. 2) with Remote Data Splitting File (D of FIG. 2) to form a logical unit, and converting logical unit into User Generated File (E of FIG. 2).

2. Connecting Failed: AIR Ware displays a message about connection failure on Client Computer.

### REFERENCE

1. Data Striping
From Wikipedia, the free encyclopedia
Author and date unknown
Website: http://en.wikipedia.org/wiki/Data_striping

2. Standard RAID Levels
From Wikipedia, the free encyclopedia
Author and date unknown
Website: http://en.wikipedia.org/wiki/Standard_RAID_levels

3. Exclusive or, “XOR”
From Wikipedia, the free encyclopedia
Author and date unknown
Website: http://en.wikipedia.org/wiki/XOR

The embodiments of the invention in which an exclusive property or privilege is claimed are defined as follows:

1. Assembling of isolated remote data, referred to as AIR Storage, in this technique, a complete file on client platform is split into two halves, and form two separate data split files, one is remote data splitting file, referred to remote DSF, remote DSF stored on network server, and another one is local data splitting file, referred to local DSF, local DSF stored on external memory device of client platform, wherein local means client platform.

2. The data assembling is an activity across network both side platforms, data splitting files both from remote server and local external memory device flow to local Random Access Memory and through data assembling to form a complete file, wherein data splitting file referred to as DSF.

3. The DSF recited in claim 2 wherein said DSF is isolated, it is only half data of a complete file, in absence of network condition, it becomes sleep file not being used alone, one DSF's another half of corresponding DSF is separated by network and stored in remote platform, not being located on same platform, it accept user direct instruction to recover complete file, rather than by system automatic operation.

4. AIR ware is processing unit of AIR storage located on client platform, its main function is to split a file into remote DSF and local DSF, and make remote DSF and local DSF lose ability to display informative content, and sent remote DSF to server for storage, sent local DSF to local external memory device for storage, when file needs to be used, AIR ware assemble data to recover file to complete state, and display on client platform.

5. The local DSF recited in claiml wherein said AIR Storage has a feature of user autonomously operate local DSF on client platform, and AIR Storage has another feature of local DSF control remote DSF.

6. The AIR Storage recited in claim 1 wherein said remote DSF and local DSF are integrated same internal code by AIR ware, the internal code is not altered after generation, and it is copied together with local DSF.

7. The remote DSF recited in claim 1 wherein said remote DSF is a deep hidden file in server-side, it is not displayed on server and client platform independently, not known to user, and nor to be found trace in server side by ordinary technical means, in addition to using local DSF and its internal code, there is no way to locate and download it.

8. The local DSF recited in claim 5 wherein said user clicks icon of local DSF on client platform to send command to serve for download corresponding remote DSF.

9. The remote DSF recited in claim 7 wherein said download command sent from local DSF to server, server will ask user to enter login name and password of user's network account.

10. The remote DSF recited in claim 9 wherein said user login information and AIR ware kernel code of hardware are essential part of server check information, information does not comply with original record of server, server will refuse download corresponding remote DSF.

11. The remote DSF recited in claim 9 wherein said remote DSF on server side can be re-split and stored in multiple servers, in this case, as long as the download command issued from local DSF is received by a splitting part of corresponding remote DSF, other splitting parts will pass on command each other and simultaneous download.

12. The AIR ware recited in claim 4 wherein said AIR ware is a chip integrated AIR storage application, which is a tool of splitting and assembling data, it is a conversion center of file type, it is a transmission channel of remote DSF and local DSF, and it is a security equipment of data splitting files.

13. The AIR ware recited in claim 4 wherein said AIR ware is with hardware kernel code, when command sent from local DSF to network server for downloading corresponding remote DSF, hardware kernel code of AIR ware is also sent to server for server verification.

14. The AIR ware recited in claim 4 wherein said AIR ware can be permanently installed on computer motherboard and be made into an external device for user to carry.

15. The hardware kernel code of AIR ware recited in claim 13 wherein said hardware kernel code of AIR ware is hidden code, and it is encrypted when sending to server, and decrypted by server.

16. The hardware kernel code of AIR ware recited in claim 13 wherein said if hardware kernel code of AIR ware do not match server record, the server will ask user to provide detailed identity information and other advance agreed authentication information, only server inspection passed, remote DSF downloading will be processed.

17. The hardware kernel code of AIR ware recited in claim 13 wherein said local DSF of client platform must go through AIR ware before entering assembling program, local DSF bypass AIR ware directly into Random Access Memory of client computer will lose assembling capability.

18. The AIR ware recited in claim 4 wherein said AIR ware split file data, meanwhile automatically generate internal code and integrate it in remote DSF and local DSF, only files with internal code can be accepted by AIR ware and allowed to enter AIR storage procedure.

19. The AIR ware recited in claim 4 wherein said All remote DSF and local DSF flowing in system must go through AIR ware channel, all command of downloading remote DSF must go through AIR ware channel to sent to server, all download command sent to server must be encrypted by AIR ware, all remote DSF downloaded will first be encrypted by server and then decrypted by AIR ware.

20. The AIR ware recited in claim 4 wherein said AIR ware integrated login-only memory, which provides users with another option, user do not need to repeatedly login server himself, and system does not need to be always in login status.

21. The login-only memory recited in claim 20 wherein said AIR ware integrated micro memory, specifically for temporary storage of user's login name and password of network account, when user initiate local DSF, one-time only enter login information, then no matter how many times file is initiated, user's login information is directly transmitted by AIR ware to server.

22. The login-only memory recited in claim 20 wherein said login-only memory transit login processes is hidden and will not display on computer monitor.

23. The login-only memory recited in claim 20 wherein said as physical characteristics of memory, once power supply of AIR ware is interrupted, user login information in login-only memory all at once disappear.

24. The login-only memory recited in claim 20 wherein said the data flow channel of login-only memory is restricted, it is only for temporary store user login information, and any other data is to be denied access to memory.

25. The AIR storage recited in claim 1 wherein said after complete file displayed on computer monitor, regardless of whether there is file modifying, as long as file is saved with AIR storage method again, the data will be re-split, and then data content of data splitting files changed, the original data splitting file will be overwritten.

26. The AIR ware recited in claim 4 wherein said AIR ware provides write-protect function, if user set up write-protect, system will refuse file to be repeat save and modify, in this case, data content of local DSF does not change frequently, and is suitable for long-term backup.

27. The AIR ware recited in claim 4 wherein said AIR ware split data so as to make file lose ability to display informative content, AIR ware does not have functionality of multiple data splitting, file is split into two halves only, and one is remote DSF, another is local DSF.

28. The AIR ware recited in claim 4 wherein said AIR ware set data splitting file flow, remote DSF only flow to server for storage, local DSF only flow to external memory device of client platform for storage, wherein local DSF has interface icon, remote DSF has no interface icon.

29. The AIR ware recited in claim 4 wherein said user click icon of local DSF to send command to network server, meanwhile to send file internal code of local DSF, first thing is to retrieval server address from AIR ware, then command and internal code is encrypted by AIR ware, and then command and internal code together with hardware kernel code of AIR ware are sent to network interface card.

30. The AIR ware recited in claim 4 wherein said AIR ware listens to port of network interface card, if server responds, AIR ware receive remote DSF through network interface card, decrypt and transmit Remote DSF to Random Access Memory, meanwhile local DSF flows through AIR ware to Random Access Memory, and two parts of data splitting files start assembling.

31. The AIR ware recited in claim 4 wherein said user deletes local DSF and sent server a command to delete corresponding remote DSF, if network is not connected, AIR ware will memorize deleting command, once network is connected, AIR ware automatically sent server deleting command through network interface card.

32. The AIR Storage recited in claim 1 wherein said the process of splitting data is completed in local Random Access Memory.

33. The data assembling recited in claim 2 wherein said remote DSF is downloaded to local platform and assembled with local DSF to form a logical unit, then the data splitting file convert into a full data file, and it is with special algorithms to achieve data assembling and files recovery.

34. The remote DSF recited in claim 7 wherein said remote DSF of server-side must accept the commands of local platform, and file assembling process is only done in the local platform and only user issue command to server.

35. The local DSF recited in claim 8 wherein said in the case of network broken, the data splitting file stored in external memory device is a sleep file, and no meaningful informative content display.

36. The AIR Storage recited in claim 1 wherein said data striping and assembling platform must be on client platform and server do not perform any operation.

37. The AIR Storage recited in claim 1 wherein said data splitting file is generated in Random Access Memory.

38. The data splitting file recited in claim 37 wherein said data splitting file is separately transmitted to local external memory device and remote server for storage from local Random Access Memory.

39. The data assembling recited in claim 33 wherein said the process of file data assembling is completed in local Random Access Memory.

40. The data assembling recited in claim 33 wherein said file data in local Random Access Memory devices, there are two options for user to save file, they are text save, in this case, all change of file is saved in the form of complete file, and DSF save, in this case, file is automatically split into two data splitting file and overwrite original file.

41. The save option recited in claim 40 wherein said selecting text save and further there are two options, they are temporarily stored in Random Access Memory despite disappear after computer shut down, and transferred to external memory device or remote server for storage, in this case, original data splitting file is automatically deleted.

42. The data assembling recited in claim 39 wherein said the local Random Access Memory set aside a special area for data splitting and assembling activities, so as not to conflict with other types of data streams in system.

43. The data assembling recited in claim 42 wherein said the two data splitting files in Random Access Memory must be successful assembled, and data is not effectively assembled, file becomes a dead one.

44. The save option recited in claim 41 wherein said when user selects DSF save mode, file is only activated in case of connecting to network.

45. The local DSF recited in claim 5 wherein said local DSF is able to be copied between different local external memory devices, also be multiple backup in some external memory devices, such as hard disk RAID1, in order to prevent data loss, and enhance equipment operation speed.

46. The local DSF recited in claim 45 wherein said in poor state of network connection or poor state of network transmission, remote DSF of server-side sometimes is not downloaded to local Random Access Memory; in this case, local DSF is not activated.

47. The AIR ware recited in claim 4 wherein said copy function in AIR ware have two options for user, they are copied files not allow to be modified, and copied files allow to be modified.

48. The copy function recited in claim 47 wherein said user selects function of copied files not allow to be modified, once file is modified and asked to save, new file is subjected to re-striping by AIR ware, and in the form of new data splitting file to be stored, new file does not overwrite original data splitting file.

49. The copy function recited in claim 47 wherein said user selects function of copied file allow to be modified, and use copied file to modify full text, then original file is void.

50. The save option recited in claim 41 wherein said data splitting file can be converted into complete data file according to user's selection, and to be stored in external memory device or remote server.

51. The save option recited in claim 50 wherein said after file type changed, complete data file is freely transmitted and displayed, no longer subject to constraints of AIR Storage rules.

52. The save option recited in claim 50 wherein said after file type changed, local DSF and remote DSF is automatically deleted by system, and this process is not reversed.

53. The save option recited in claim 50 wherein said user wants to re-convert complete data file to data splitting file, AIR ware reproduce data splitting files for local platform and remote server to store, new file have characteristics of AIR Storage.

54. The remote DSF recited in claim 7 wherein said remote DSF downloaded from remote server to local platform is confined to be stored in Random Access Memory, and it is not transferred to local external memory device.

55. The data assembling recited in claim 39 wherein said AIR ware will automatically generate a new file to replace assembled file, the file style of new file will fully adapt to the requirement of system, the newly generated file only temporarily saved and run on Random Access Memory, during this period, any changes made to file can be saved in Random Access Memory.

56. The AIR ware recited in claim 4 wherein said AIR ware does not restrict the type and model of the external memory device, as long as user chooses Air Storage function, every external memory device will work.

57. The AIR ware recited in claim 4 wherein said AIR ware does not restrict data splitting files to be stored together with other types of complete files in same external memory device, but AIR ware only work for data splitting file.

58. The AIR Storage recited in claim 1 wherein said in AIR Storage, file have four identifier for server recognize, they are file name, and internal code of DSF, and user's login information, and hardware kernel code of AIR ware.

59. The internal code of DSF recited in claim 4 wherein said data splitting file is generated, at the same time the AIR ware assign an internal code to file as system identifier, internal code of DSF is invisible code for system identification, user cannot detect.

60. The internal code of DSF recited in claim 59 wherein said deleting data splitting files of both side of network, simply delete local DSF, in this case, internal code of local DSF is also deleted, and this deleting action of internal code of local DSF is transformed into command of deleting corresponding remote DSF.

61. Deleting data splitting file recited in claim 60 wherein said user deletes local DSF from external memory device and just click file icon, the command of deleting corresponding remote DSF is sent to system in a timely manner.

62. Deleting data splitting file recited in claim 61 wherein said in case of network broken, AIR ware will memorize deleting command until network is connected, once network is connected, server automatically deletes the corresponding remote DSF according to internal code of DSF.

63. Deleting data splitting file recited in claim 62 wherein said pending procedure of deleting command applies to both of original file and copied file.
